(19) United States
(12) Patent Application Publication
(10) Pub. No.: US 2004/0085578 A1
(43) Pub. Date: May 6, 2004

(54) Producing personalized photo calendar

(76) Inventors: Su Mien Quek, San Francisco, CA (US); Kevin Patrick Rogan, Los Gatos, CA (US); Christine Y. Hsu, San Jose, CA (US); Patrick C. Teo, San Mateo, CA (US)

Correspondence Address: TRAN & ASSOCIATES, 6768 MEADOW VISTA CT., SAN JOSE, CA, 95135, US

(21) Appl. No.: 10/287,279

(22) Filed: Nov. 3, 2002

(51) Int. Cl. G06F 15/00; G06K 1/00

(52) U.S. Cl. 358/1.18; 358/402

(57) ABSTRACT

A method for producing an image-based product includes displaying a layout of the image-based product including at least one image field for receiving a digital image, selecting one or more digital images from an image source, storing the selected digital images in an image collection and moving one of the selected digital images stored in the image collection into the image field in the layout of the image-based product.

The present invention is related to commonly assigned U.S. patent application Ser. No. 09/436,704, filed on Nov. 9, 1999, titled “Distributing Images to Multiple Recipients”, by Baum, U.S. patent application Ser. No. 09/450,075, filed on Oct. 27, 1999, titled “Printing Images in an Optimized Manner”, by Baum, et al., U.S. patent application Ser. No. 09/428,871 filed Oct. 27, 1999, titled “Multi-Tier Data Storage System”, U.S. patent application Ser. No. 09/721,484, filed on Nov. 22, 2000, titled “User Interface and Methods for On-line Print Service”, by Manolis, et al., U.S. patent application Ser. No. 09/450,804, filed on Nov. 29, 1999, titled “Image Uploading”, by Manolis, et al., U.S. patent application Ser. No. 09/560,609, filed on Apr. 28, 2000, titled “System and Method of Providing a User Interface for Changing Attributes of an Image-based Product”, by Haeberli, U.S. patent application Ser. No. 09/684,595, filed on Oct. 5, 2000, titled “Previewing a framed image print ”, by Haeberli, and U.S. patent application Ser. No. 10/106,902, filed on Mar. 25, 2002, titled “Producing and sharing personalized photo calendar”, by Weitzman et al. The disclosure of these related applications are incorporated herein by reference.

### TECHNICAL FIELD

This application relates ti) creating personalized image-based products and personalized viewable images.

### BACKGROUND

Calendars are typically printed with static designs and in large quantities. They can commonly be purchased at bookstores and other retail locations. In everyday use, calendar users often put reminders on calendars by marking their personal events at the corresponding dates on a calendar page. The personal events can include social gatherings, school activities, vacations, and bill payment, etc. For aesthetic reasons, it may be useful to have such personal event information printed on the calendar. For example, U.S. Pat. No. 6,269,341 discloses “a method and system for making an individualized calendar which includes personalized information. The personalized information includes a special event date with its description for an individual for whom the calendar is to be made.” Calendars generally show dates of January through December, and users usually purchase them at the end of the previous year. Some users may have the additional needs for “a calendar producing system, a producing method, a selling system and a selling method in which a calendar can be produced and purchased all through the year and can be delivered to a user quickly”, as disclosed in U.S. patent application Ser. No. 20010010772.

### SUMMARY

The invention relates to methods and a system for producing a personalized photo calendar. The method includes a) displaying a layout of the image-based product including at least one image field for receiving a digital image, b) selecting one or more digital images from an image source, c) storing the selected digital images in an image collection, d) moving one of the selected digital images stored in the image collection into the image field in the layout of the image-based product.

The system may include one or more of the following. The system provides an electronic or a hardcopy personalized calendar. The system provides a personalized calendar including a user's personal photos. The resulting online photo system allows a user to create a personalized photo calendar, to purchase a hardcopy of the personalized photo calendar and to ship it to a recipient as specified by the user. The system provides an efficient graphical user interface for creating a personalized photo calendar. The digital images stored in a user account at a photo hosting website are first selected and collected in an image collection. A layout of the image-based product is displayed. The layout includes one or more image fields for receiving digital images. An advantage of the present invention is that it provides effective method and system for selecting and moving digital images in the image collection and filling the image fields in the layout. The calendar layout including the received digital images is rendered to produce personalized photo calendar that can be viewed electronically or reproduced in hardcopies. Another advantage of the present invention is that the digital images stored in the image collection can be used in a plurality of different image-based products so that a user does not need spend redundant time to re-select suitable images for creating different image-based products. Yet another advantageous feature of the present invention is that the rendered calendar layout can be saved as a project that can be extracted in future use. User's time is saved from re-entering the calendar design parameters.

Other advantages of the present invention include that the calendars are customized with a user's personal pictures, personal message or event information. The personalized photo calendars are appealing and valuable for keeping personal memories or as gifts to family members and friends.

A further advantage of the present invention is that the personalized photo calendar can be conveniently created, and a hardcopy calendar ordered on at a photo hosting website on the Internet from a user's computer. The user can conveniently select her personal photos from her photo albums stored at the photo hosting website to create a personalized photo calendar. Upon receiving an order for a hardcopy of such a personalized photo calendar, the photo service provider hosting the website can produce a hard copy of the personalized photo calendar and have it shipped to the recipients as specified by the user.

The details of one or more embodiments are set forth in the accompanying drawings and in the description below. Other features, objects, and advantages of the invention will become apparent from the description and drawings, and from the claims.

### DRAWING DESCRIPTIONS

FIG. 1 is an exemplary block diagram showing a system for producing personalized photo calendars in accordance with the present invention.

FIG. 2 shows a typical computer that a user uses for receiving digital image data from a digital image capture device and for accessing a photo hosting website on the Internet.

FIG. 3 shows an example of a graphical user interface as viewed on the computer display for creating a personalized photo calendar.

FIG. 4 shows another example of a graphical user interface for creating a personalized photo calendar. The image filed overlaps with the date information in the calendar layout.

FIG. 5a shows a perspective preview of a hardcopy personalized photo calendar. The hardcopy personalized photo calendar comprises a personalized cover page including a user's personal photos.

FIG. 5b shows a calendar page from the calendar book shown in FIG. 5a.

FIG. 5c shows a planar view of two hardcopy personalized photo calendars in different formats.

FIG. 6 shows another layout of a personalized photo album in which the dates and the personal photos are distributed in a plurality of cells.

FIG. 7 is an illustration of an electronic calendar including a user's personal event information associated with different dates. The personal event information can be extracted by an application program for producing a personalized photo calendar for the user.

FIG. 8 shows a flow diagram for creating personalized photo calendar at a photo hosting website on the Internet.

FIG. 9 illustrates an empty image collection for collecting digital images to be used in personalized photo calendar before digital images are collected and stored in the image collection.

FIG. 10 shows a view of a user's image album at a photo hosting website.

FIG. 11 illustrates an image collection in the form of an Hypertext Markup Language layer in a web page.

FIG. 12 illustrates a layout for a personalized photo calendar including plurality of image fields each associated with a month.

FIG. 13 illustrates the cover of a personalized photo calendar including an image field and a message field for entering personalized information.

FIG. 14 illustrates the previewing of a page in a personalized photo calendar.

### DETAILED DESCRIPTION

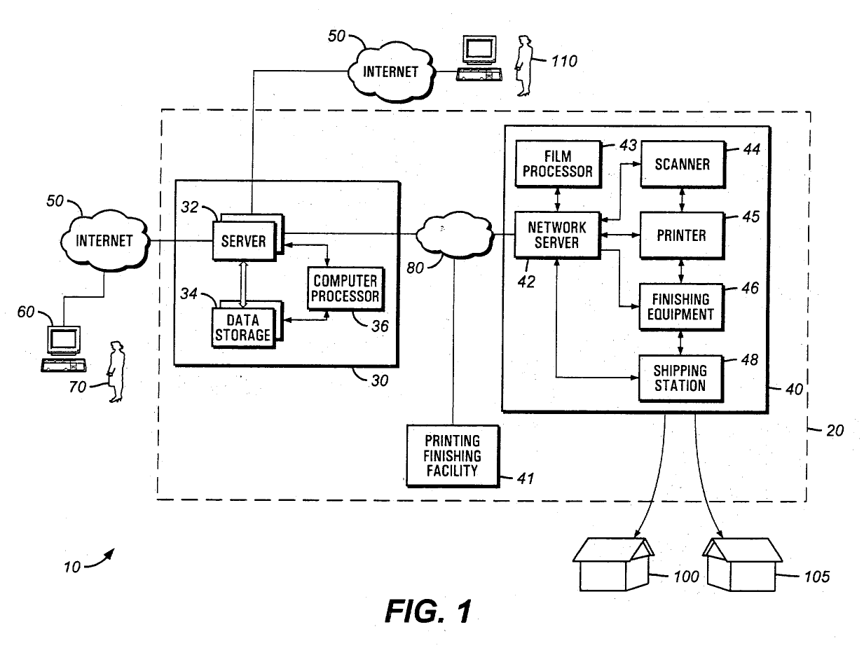

FIG. 1 shows a block diagram of the system 10 for producing personalized photo calendars in accordance with the present invention. An online photo system 20 is established by a photo service provider to provide photo services on a wide area network such as the Internet 50. The online photo system 20 includes a data center 30 and one or more printing and finishing facilities 40 and 41 The data center 30 includes one or more servers 32, data storage devices 34 for storing image data, user account and order information, and one or more computer processors 36 for processing orders and rendering digital images. An online-photo website is powered by the servers 32 to serve as a web interface between the users 70 and the photo service provider. The printing and finishing facilities 40,41 can produce hardcopy photo products such as personalized photo calendars, photographic prints, greeting cards, post cards, trading cards, hardcopy photo albums, photo books, photo T-shirt, photo mugs, and record images on compact disks (CDs).

The architecture of the data storage devices 34 are designed to optimize the data accessibility, the reliability of the data storage and the cost. Further details on the image data storage in online photo system 20 are provided in the commonly assigned and above referenced U.S. patent application Ser. No. 09/428,871 filed Oct. 27, 1999, titled “Multi-Tier Data Storage System”, which is incorporated herein by reference.

The printing and finishing facilities 40,41 can be co-located with the data center 30. Or alternatively, the printing and finishing facility 40,41 can be remotely located from the data center 30. Multiple printing and finishing facilities 40,41 can be set up so that each printing and finishing facility 40,41 can be located geographically close to the customers to shorten order delivery time. Furthermore, the printing and finishing facilities 40,41 and the data center 30 can be owned and operated by different business entities. For example, the data center 30 can be owned by a first business entity that hosts a website that provides a web front and web user interface for the user 70. The printing and finishing facilities 40,41 can be owned by a second business entity that fulfills the production of physical photo products for the first business entity. In this particular arrangement, the second business entity is often referred as an Application Service Provider (ASP). The photo service provider can provide services to its customers from its own website, as well as fulfill (i.e. ASP) photo products for websites hosted by other business entities.

The printing and finishing facility 40 includes network servers 42 for communicating with the data center 30, printers 45 for printing images on physical surfaces, finishing equipment 46 for operations after the images are printed, and shipping stations 48 for confirming the completion of the orders and shipping the ordered photo products to recipients 100 and 105 (the user 70 can be a recipient). The printing and finishing facilities 40,41 can include a film processor 43 for processing exposed films, and a scanner 44 for digitizing a processed film stripe. The network servers 42 are connected with the data center 30 via a computer network 80 such as a Local Area Network or a Wide Area Network. The order information and image data can be transferred from servers 32 to the network servers 42 using a standard or a proprietary protocol (FTP, HTTP, XML, etc.). The finishing equipment 46 can perform any operations for finishing a complete photo product other than photo printing such as cutting, folding, adding a cover to photo book, punching, stapling, gluing, binding, envelope printing and sealing, packaging, labeling, weighing and postage metering. The finishing operations can also include framing a photo print, recording image data on a CD-ROM, etc. Furthermore, the printers and the finishing equipments can be located in different sites. Some of the finishing operations may be fulfilled by contracting an external finishing provider.

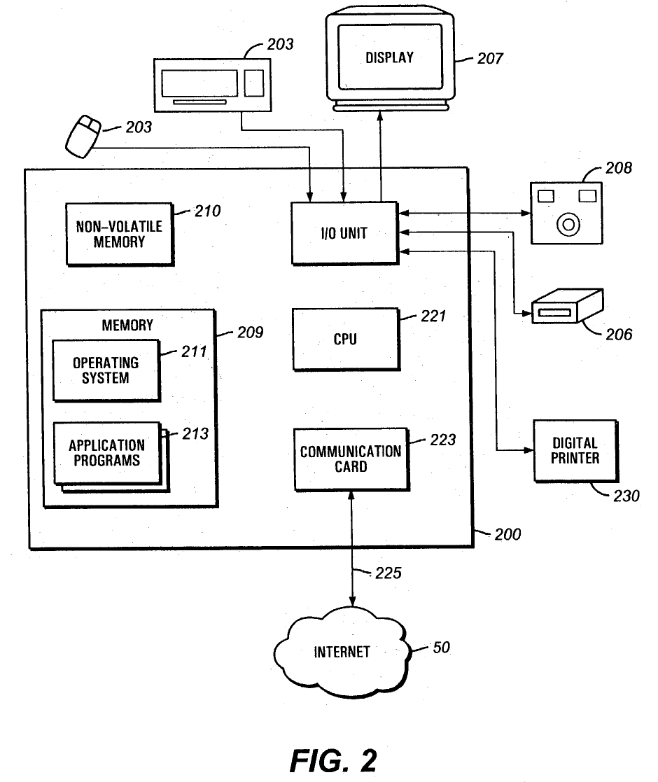

A user 70 can access the online-photo website using a computer terminal 60 as shown in FIG. 2. The computer terminal 60 can be a personal computer located at a home or at a business, or a public entry terminal such as a kiosk. The computer terminal 60 allows a user 70 to execute software to perform tasks such as communicating with other computer users, accessing various computer resources, and viewing, creating, or otherwise manipulating electronic content, that is, any combination of text, images, movies, music or other sounds, animations, 3D virtual worlds, and links to other objects. Exemplary components of the computer terminal 60, shown in FIG. 2, include input/output (I/O) devices (mouse 203, keyboard 205, display 207) and a general purpose computer 200 having a central processor unit (CPU) 221, an I/O unit 217 and a memory 209 that stores data and various programs such as an operating system 211, and one or more application programs 213 including applications for viewing, managing, and editing digital images (e.g., a graphics program such as Adobe Photoshop). The computer 200 also includes non-volatile memory 210 (e.g., flash RAM, a hard disk drive, and/or a floppy disk, CD-ROM, or other removable storage media) and a communications device 223 (e.g., a modem or network adapter) for exchanging data with an Internet 50 via a communications link 225 (e.g., a telephone line).

In accordance with the present invention, the computer 200 allows the user 70 to connect to the online-photo website using the communications card or device 223. The user 70 can set up and access her personal account. The user 70 can enter user account information such as the user's name, address, payment information (credit card number), and information about the recipient of the photo products ordered by the user 70. The user 70 can also enter payment information such as credit card number, the name and address on the credit card etc. The user 70 can also send digital image data to the online-photo website.

Other user operations can include storing the images in a photo album online, creating personalized photo calendar, and ordering a hardcopy personalized photo calendar. In addition, the user 70 can order hardcopy personalized photo calendars and have them shipped to recipients 100 and 105. The user 70 can also share her personalized photo calendar with a share recipient 110 on the Internet 50. Upon receiving the personalized photo calendar from the user 70, the share recipient 110 is authorized to order a hardcopy o personalized photo calendar 500 (as discussed in more detail below) from the online photo website provided by the photo service provider.

In the present application, the term “hardcopy” in hardcopy photo album and hardcopy photo calendar refer to the physical products that need to be printed and finished. Whereas the term “photo album” refers to the image-holding entities in a local computer or at a photo web site for organizing digital images stored in an electronic media.

The computer 200 of FIG. 2 can also be connected to various peripheral I/O devices such as an image capture device (digital camera, film or reflective scanners). One such peripheral device is a digital camera 208 that enables users to take pictures and save them in digital (electronic) format. Typically, the digital camera 208 is connected to the computer 200 only while the user is transferring images to the computer's disk drive or other non-volatile memory 210. The digital camera 208 can be connected to the computer 200 using a Firewire or an USB port, from a camera cradle (e.g. Kodak DX3900 using an EasyShare Camera Dock), or over wireless media such as radio or light. The digital images captured by a digital camera are typically stored in memory card (e.g., SmartMedia™ or CompactFlash™) that are detachable from the digital camera. The digital images on a memory card can be transferred to the computer 200 using a card reader 206 and saved on non-volatile memory 210.

The user 70 can also obtain digital images from film-based prints from a traditional camera, by sending an exposed film into a photo-finishing service, which develops the film to make prints and/or scans (or otherwise digitizes) the prints or negatives to generate digital image files. The digital image files then can be downloaded by the user or transmitted back to the user by e-mail or on a CD-ROM, diskette, or other removable storage medium. The users can also digitize images from a negative film using a film scanner that is connected to the computer 200 or from a reflective image print using a flatbed scanner. Digital images can also be created or edited using an application program 213 (e.g., a graphics program such as Adobe Photoshop).

Once the digital images are stored on the computer 200, a user can perform various operations on them using application programs 213 stored in memory 209. For example, an image viewer application can be used for viewing the images and a photo editor application can be used for touching up and modifying the images. In addition, an electronic messaging (e.g., e-mail) application can be used to transmit the digital images to other users. In accordance with the present invention, one of the application programs 213 can enable the user 210 creating a personalized photo calendar on the computer 200. Several of the above described imaging functions can be incorporated in one imaging software, which can be provided by the photo service provider and installed on computer 200 for the user 70. More details about application programs 213 for image enhancement and image management.

In addition to viewing the digital images on the computer display 207, the user 70 may desire to have physical photo products made of digital images. Photo prints can be generated by the user 70 using a digital printer 230 that is connected to the computer 200. Typical digital printers 230 can include such as an inkjet printer or a dye sublimation printer. The user 70 can also purchase from an online photo service provider photo products that are not easily produced at home or even at a retail store. In accordance with embodiments of the present invention, examples of such photo products may include personalized photo calendars, photo prints based on silver halide photographic paper (versus ink jet receiver used by ink jet printers), personalized photo greeting cards, photo books and albums, photo T-shirt, and photo, mugs etc. The production of these photo products often require the use of commercial equipment which are usually only available at a commercial production location such as the printing and finishing facilities 40 and 41. One online photo service provider that makes such photo products is Shutterfly, Inc., located at Redwood City, Calif., U.S.A.

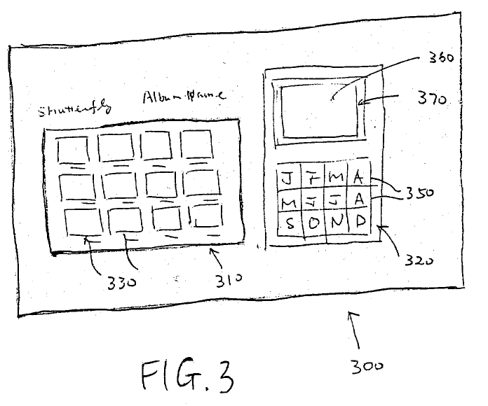

In accordance with the present invention, the user 70 can be a consumer that accesses the computer terminal 60 from home or a public entry terminal. The user 70 can also be a business owner or employee that may access the computer terminal 60 at a retail location such as a photo shop or a printing store. In the latter case, the digital images may be generated by a customer of the business and later provided the business for receiving an imaging service. An advantage of the present invention, as described above, is that it allows the business to provide photo products that are otherwise unavailable at the business location. For example, the hardcopy personalized photo calendars 500 may require the use of commercial printing press and finishing equipment that are typically not available at retail business locations. The formats of communication between the computer terminal 60 and the servers 32 as well as the graphic user interface (as described below relating to FIGS. 3 through 7) can be customized for the consumer and commercial customers.

The computer terminal 60 can also be a public entry terminal such as a kiosk for receiving digital image data from the user 70 and uploading the digital images to the server 32. After the digital image files have been uploaded, the user can view, manipulate and/or order prints in the manners described above. The public entry terminal can also support various electronic payment and authorization mechanisms, for example, a credit or debit card reader in communication with a payment authorization center, to enable users to be charged, and pay for, their prints at the time of ordering.

A typical process of using an online photo service is now described. The user 70 sends digital images to the servers 32 provided by the online photo system 20 by uploading over the Internet 50 using a standard or a proprietary protocol (FTP, HTTP, XML, for example) or electronic communication application (for example, e-mail or special-purpose software provided by the photo-finisher). The user 70 can also send digital image data stored on a physical storage medium such as a memory card or recordable CD by US mail, overnight courier or local delivery service. The photo-finisher can then read the images from the storage medium and return it to the user, potentially in the same package as the user's print order. In addition, the photo-service provider can load data or programs for the user's benefit onto the storage medium before returning it to the user. For example, the photo-finisher can load the storage medium with an application program 213 for the user to create a personalized photo calendar on his computer 200.

The user can also send a roll of exposed film, and processed film negatives to the photo service provider. The exposed film is processed by the film processor 43 and digitized by the scanner 44 in the printing and finishing facilities 40, 41. The digital image data output from the scanner 44 is stored on the data storage 34.

After the photo service provider has received the user's digital images, the photo service provider can host the images on the online photo website, at which the user can view and access the images using a browser application. The user 70 accesses the online-photo website to designate which of the images should be reproduced on a photo product, parameters relating to printing (e.g., finish, size, number of copies), and one or more recipients 100, 105 to whom the photo products are to be sent.

In addition to hosting the user's images on a web page, the photo service provider usually stores the images in an image archive on in the data storage 34 so that the user 60 and others given authorization by the user (e.g. the share recipient 110) can access them in the future.

After the user's images have reached the photo service provider and have been made available online, the user can place an order with the photo service provider. One way to place an order is by having the user 70 view the images online, for example, with a browser and selectively designate which images should be printed. The user can also specify one or more recipients 100,105 to whom prints should be distributed and, further, print parameters for each of the individual recipients, for example, not only parameters such as the size, number of copies and print finish, but potentially also custom messages to be printed on the back or front of a print.

The information stored in the data storage 34 is provided to a printing and finishing facilities 40,41 for generating photo products. The photo products include photographic prints, but also any other item to which graphical information can be imparted, for example, greeting or holiday cards, books, calendars, playing cards, T-shirts, coffee mugs, mouse pads, key-chains, or any other type of gift or novelty item. The photo products are printed by the printer 45 and finished by finishing equipment 46 according to the printing parameters as specified by the user 70. The photo products are then delivered to the specified recipients 100, 105 using standard U.S. Mail, or courier services such as Federal Express or UPS. Further details on the generation and distribution of photo products using online photo system 20 are provided in the commonly assigned and above referenced U.S. patent application Ser. No. 09/436,704, filed on Nov. 9, 1999, titled “Distributing Images to Multiple Recipients”, by Baum and U.S. patent application Ser. No. 09/450,075, filed on Oct. 27, 1999, titled “Printing Images in an Optimized Manner”, by Baum, et al. The disclosures of these patent applications are herein incorporated by reference.

FIG. 3 shows a graphical user interface 300 as viewed on the computer terminal 60 by the user 70. The graphical user interface 300 can be a web page provided from a website hosted by the photo service provider and viewable using a web browser program such as Microsoft Internet Explorer or Netscape. The graphical user interface 300 can also be provided by a local application program 213 residing on the computer 200. The graphical user interface 300 includes a photo album 310 and a calendar layout 320. The photo album 310 includes a plurality of digital images 330 that are provided by the user 70. A detailed view of a digital image 330 can be obtained by clicking on the digital image with a mouse, for example. The digital images 330 may be originally captured by a digital camera and subsequently transferred to the computer 200, as previously described. The digital images 330 may also have been digitized from a reflective print or film. The digital images 330 include personal photos from the user 70. In the case that the graphical user interface 300 is a web page from online photo website powered by the server 32, the digital images 330 have been sent to the server 32 either by data transfer over the Internet 50 or by mailing a memory device containing the digital images to the photo service provider. Details of uploading a user's digital image to an online-photo hosting website are disclosed in the commonly assigned and above referenced U.S. patent application Ser. No. 09/450,804, filed on Nov. 29, 1999, titled “Image Uploading”, by Manolis, et al., the disclosure of which is are incorporated herein by reference.

Although not shown, the graphical user interface 300 can include tools for image enhancement and management. For example, the user 70 can use such image enhancement tools to crop a digital image 330 for the use in the personalized photo calendar (as described below), to change the colors (e.g. to black and white, or sepia, etc.), to apply special effects such as water color or oil painting on the digital image 330. The image enhancement tools also allow the user 70 to change tone scale, fix red eyes, or add a border to the digital image 330. The graphical user interface 300 also allows the user 70 to add and edit a title, annotation, and keywords to a digital image 330. The image management tools allow the user to organize and display the digital images 330 based on keywords, titles and annotations. Details of the graphical user interface for viewing and managing a user's photo albums, and for managing the user account and recipient information are disclosed in the commonly assigned and above referenced U.S. patent application Ser. No. 09/721,484, filed on Nov. 22, 2000, titled “User Interface and Methods for On-line Print Service”, by Manolis, et al., the disclosure of which is are incorporated herein by reference.

The calendar layout 320 includes a plurality of cells 350, each of which is associated with a date. For example, there can be twelve cells 350 with each representing a month in a year as shown in FIG. 3. The calendar layout can include information ethnic calendars (a lunar calendar, Chinese calendar, among others) including ethnic and/or religious holidays. In accordance with the present invention, the calendar layout 320 further includes one or more image fields 360 for receiving a digital image.

The image field 60 can be surrounded by an image border 370. The image border 370 is pre-designed, which can provide a theme to the image. Examples of a theme can include seasons (spring, summer, among others), school, family, kids, sports, birthday, graduation, wedding, culture and ethnic information (Christmas, Thanksgiving, the year of the horse, Jewish New Year, kwanza, among others), etc. The image border 370 can be changed by selecting from pre-designed image borders. Details of about image borders, image enhancement, and graphical user interface for viewing and managing a user's photo albums are disclosed in the commonly assigned and above referenced U.S. patent application Ser. No. 09/560,609, filed on Apr. 28, 2000, titled “System and Method of Providing a Graphical user interface for Changing Attributes of an Image-based Product”, by Haeberli, the disclosure of which is are incorporated herein by reference.

The graphical user interface 300 provides functions for inputting the start date, the end date, and the time increment for the personalized photo calendar. For example, a calendar can start from Jan. 1, 2002, ends in Dec. 31, 2002, incremented by day, and grouped month by month. A calendar layout can also just cover a quarter or a month. In accordance with the present invention, the personalized photo calendar allows the user to vary the start time, the end time, as well as the time increment. For example, a user 70 may start a new calendar from July, 2000 and end in June, 2003. Another user 70 can design a calendar for only a quarter in the 3^{rd} quarter of year 2002. The user may order a hardcopy personalized photo calendar 500 every quarter so the user 70 can select most update personal photos for her personalized photo calendar.

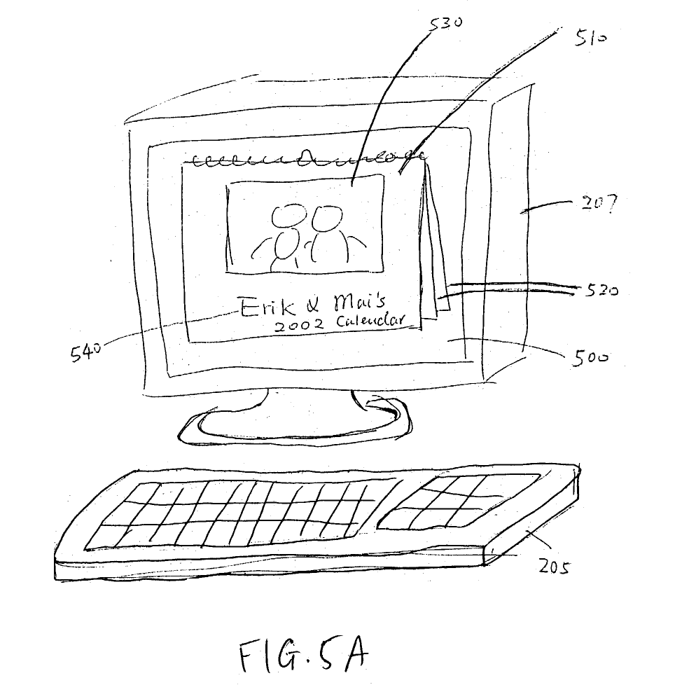

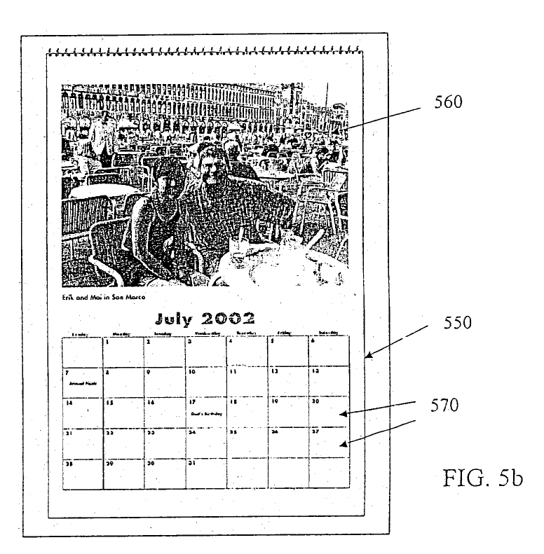

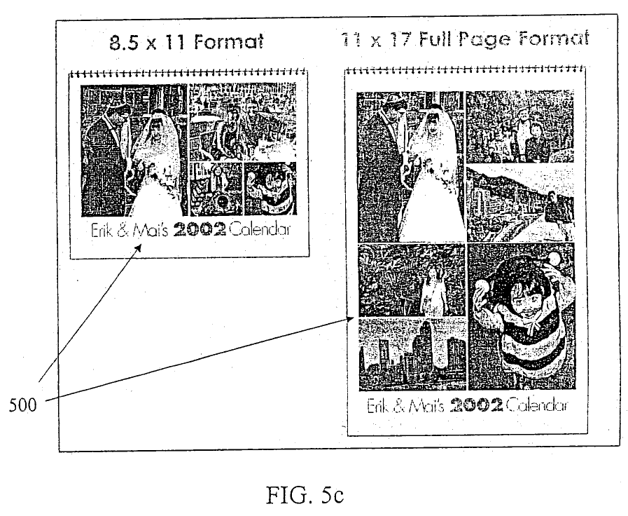

In accordance with the present invention, the user 70 can render the calendar layout 320 using one or more of the digital images 330 to produce a personalized photo calendar. The user 70 can select one of the digital images 330 by positioning the cursor to the digital image and clicking with a mouse. The user 70 can then move the selected digital image 330 into the image field 360, which forms personalized photo calendar including a user 70's personal photo. The digital image 330 can be moved by dragging and dropping the selected digital image into the image field 360 in the calendar layout 320. The user can also select and incorporate a digital image 330 into an image field 360 by browsing a directory of file folders and selecting an image file from a folder. Once a digital image 330 is moved to the image field 360, it can be replaced by a second digital image 330 by moving the second digital image 330 into the image field 360. A calendar page can include several image fields 320 for receiving a plurality of digital images 330. The digital images 330 rendered into the calendar layout can for an image collage as shown in FIG. 5c.

A calendar layout 320 can include a plurality of calendar pages. Each of the calendar pages may include one or more image fields 360 for receiving a digital image 330 from the user's personal photo album 310. In addition, a user 70 may have one or more photo albums 310 on his computer 200 or at the website powered by the server 32. In accordance with the present invention, a personalized photo calendar can be generated automatically, by selecting a plurality of digital images 330 from one or more of user 70's photo albums 310. The digital images 330 can be automatically distributed to the different image fields on different calendar pages.

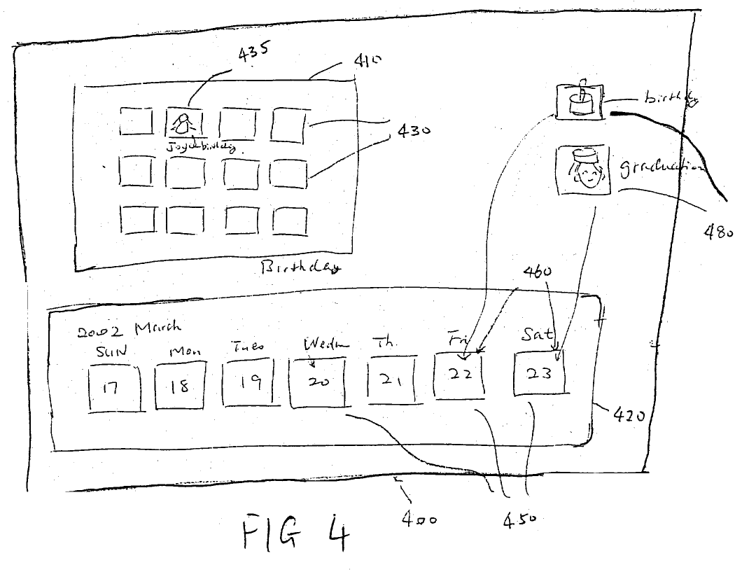

FIG. 4 shows another example of a graphical user interface as viewed on the computer terminal 60 for creating a personalized photo calendar. The graphical user interface 400 includes a photo album 410 and a calendar layout 420. The photo album 410 includes a plurality of digital images 430 provided by the user 70. Some of the digital images 435 include an annotation and/or a title associated with a digital image, for example, “Joyce's Birthday”. The calendar layout 420 includes a plurality of cells 450, each representing a date. In FIG. 4, the date information is illustrated in each of the seven cells 450 representing the seven days in a week. In accordance with the present invention, the image fields 460 in the calendar layout 420 can fully occupy or partially overlap with the cells 450 for the date information.

In accordance with one aspect of the invention, the digital image 435 with an annotation or title can be moved to an image filed 450 that is located in a date cell wherein the date corresponds to the title and the annotation. For example, the digital image 435 with “Joyce's Birthday” can be moved to the date cell for 20^{th}, Wednesday, which corresponds to the birthday for Joyce. The title and annotation information can be carried over to the calendar layout with the selected digital image 430. Personal text information “Joyce's Birthday” can also be added to the date cell in the calendar layout 420 in conjunction with the location of the image field 450. In accordance with the invention, the graphical user interface 400 allows the image field 450 and the personal text information to be moved by the user 70 according to the specific needs of the user 70.

In accordance with the present invention, the digital image 430 can include keywords describing the occasion of each digital image. A digital image 430 can include a plurality of keywords: “Tom, Dad, vacation, golf”. In preparation of creating a personalized photo calendar with a vacation theme, the user 70 can search for the key word “vacation”. A plurality of digital images 430 may be selected as candidates for being incorporated into the calendar layout 420.

Furthermore, the graphical user interface 400 can provide graphic images 480 such as clip art, which can include the graphic pattern for a “birthday cake” and a symbol for “graduation”. These graphic images can also be moved into an image field 450 in association with events such as birthday and graduation.

FIG. 5a shows a perspective view of a hardcopy personalized photo calendar 500. After a hardcopy personalized photo calendar is customarily designed, the user 70 can preview it on the graphic user interface, as shown in FIG. 5. The hardcopy personalized photo calendar 500 comprises a personalized cover page 510 and other personalized photo calendar pages 520. The calendar book is bound together by various binding methods such as coil, wire, ring binding etc. Each calendar page may be printed on both sides (i.e. duplex), or just one side (i.e. simplex printing). FIG. 5b shows a calendar page of the calendar book shown in FIG. 5a. The calendar layout 550 includes an image filed 560, and a plurality of cells 570 for illustrating the days in July 2002.

The personalized cover page 510 includes a personal photo 530, selected from the digital images 330,430 in the photo albums 310,410, and a personal title 540 provided by the user 70. The graphic user interface may provide suggestions for the personal title. The digital images for the cover may be the same as some of the digital images 330,430 that also appear on the other calendar pages. The personalized cover page 510 may present an image collection (or a collage) of digital images 330,430 which correspond to the digital images used in the personalized photo calendar page 520 as an overview of the images in the calendar book. The user 70 can preview different personalized photo calendar pages by clicking on a calendar or cover page and flip to the next page. At least one calendar page can include a machine code information (e.g. barcode) for the photo service provider 40,41 to track the orders. The status of each order can be viewed by the user 70 at the photo hosting website.

FIG. 5c shows a planar preview of two hardcopy personalized photo calendars 500 in different formats. The hardcopy personalized photo calendar 500 may include different formats: in a single sheet or the form a book, sizes in 11″×17″, 8.5″×11″, 5″×7″, and a pocket size. The hardcopy personalized photo calendar 500 shown in FIG. 5a can be displayed by hanging off a wall. The hardcopy personalized photo calendar 500 can also be for standing on a desk or shelf surface. The hardcopy personalized photo calendar 500 can also be produced on novel substrate such as magnetic pad (for sticking to a refrigerator), a mug, a plate, or locket for a dated decoration, etc. Each calendar of the same format may be received by a multiple of recipients 100, 105 as specified by user 70. In addition, each recipient 100 or 105 can receive hardcopy personalized photo calendars 500 of different formats ordered by the same user 70.

The hardcopy personalized photo calendar 500 can be printed on a photosensitive silver halide paper using a digital photo printer such as Fuji's Frontier Minilab 390, or on a coated cover paper using an offset digital press such Indigo UltraStream Press, available from Indigo Inc., a Hewlett Packard company.

The user 70 can order other photo products at the time he orders hardcopy personalized photo calendar 500 from the photo service provider on the online photo website. For example, the user 70 may also order photo prints, a CD of his photos, and a greeting card to be shipped to the same recipient 100, 105. These photo products can be consolidated in a single package together with the hardcopy personalized photo calendar 500 at the printing and finishing facility 40,41 before being shipped to the recipient 100,105 or to the user 70.

The preview of the hardcopy personalized photo calendar can be in two-dimensional pages or in perspective views. Details of the user interface for previewing including perspective previewing of a photo products are disclosed in the above referenced and commonly assigned U.S. patent application Ser. No. 09/684,595, filed on Oct. 5, 2000, titled “Previewing a framed image print”, by Haeberli, the disclosure of which is incorporated herein by reference.

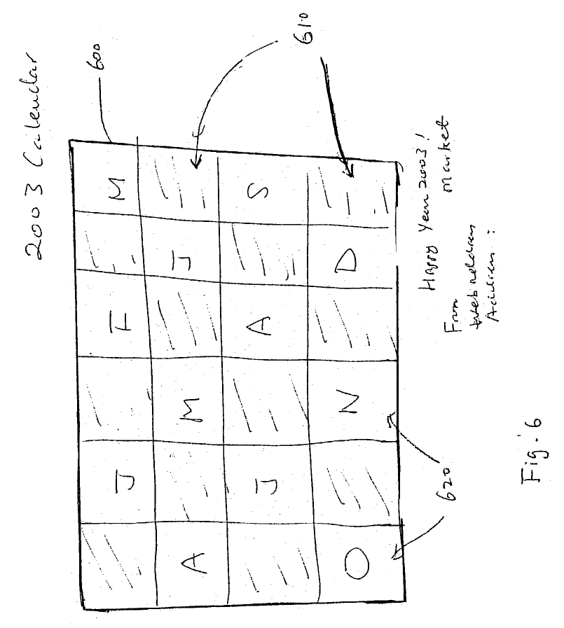

The image field 360 can appear in half of a calendar page as shown FIG. 3. Or alternatively, as shown in the calendar layout 600 in FIG. 6, the image fields 610 can be distributed next to the date cells 620 in a checker-board pattern. The design of the personalized photo calendar, in soft or hardcopy forms, can be stored on the user 70's computer 200 or on the data storage 34 connected to the server 32. The user 70 can retrieve the information to create and order a new hardcopy personal photo calendar 500 when the last one he ordered is about to be out dated. The dates for personal events such as birthday or anniversary for a user or a recipient can also be saved in the user 70's personal account. The photo service provider can send a reminder for photo products such as a birthday cards before the date of the personal events.

The calendar layout can include features that are variable by the user 70. The variable features in the calendar layout can include font size, font color, font style, background color and background pattern in the calendar layout. The background color and pattern can carry a theme such as sports, girls, school, vacation etc. The theme can also include commercial information, as shown in FIG. 6, including business name, product description, business logo, business locations, website address, e-mail and such as phone numbers, etc.

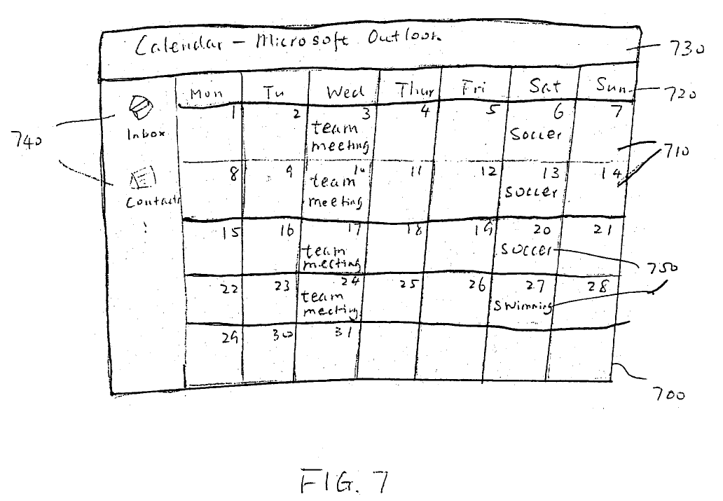

The calendar layout 320, 420 can extract information from an electronic calendar provided a personal account at a web site such as Yahoo!, or an computer application such as Microsoft Outlook, or an organization software on a portable handheld device such as Palm. FIG. 7 shows an electronic calendar 700 that the user 70 can use for scheduling activities in a desktop environment. The electronic calendar 700 can include a plurality of cells 710 for holding date information, text information 720 (e.g. Monday, Tuesday . . . ), header information 730, file folders 740 such as e-mails, address book etc., and event information 750. The event information 750 in the electronic calendar 700 can be exported to an out file, which can in turn be extracted by an application program 213 into the calendar layout 320, 420. The user 70 can selectively edit the activities to be incorporated into the personalized photo calendars.

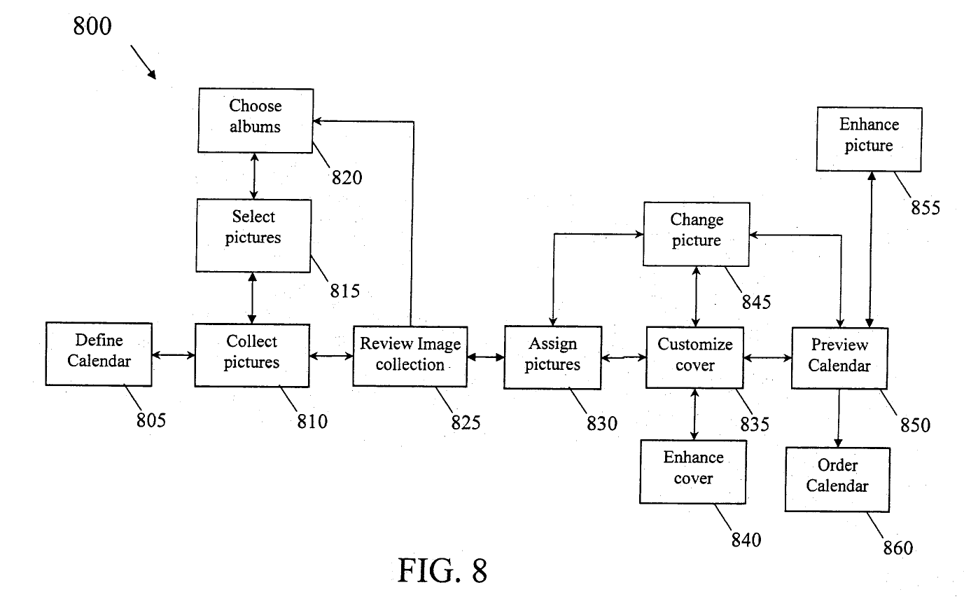

FIG. 8 illustrates a flow diagram for creating an image-based product at a photo hosting website on the Internet. The image-based products include hardcopy photo albums, photo calendars, photo books, greeting cards, photo cards, post cards, note cards, Snapbooks (that is available from Shutterfly Inc. Redwood City, Calif.), etc. As an example, FIG. 8 illustrates the workflow for creating a hardcopy personalized photo calendar and the associated personalized viewable image for the photo calendar at a photo hosting website on the Internet. It is understood that the workflow illustrated and described below are compatible with creating other image-based products using web-based or client-based graphic user interfaces.

The calendar workflow 800 starts with one or more web pages for the user 70 to define calendars (box 805). The web pages describe the features of the personalized photo calendars such as sizes, layout, list prices for different calendar options, and illustrate artistic presentations. The web pages also explain the procedure for a user 70 to create a personalized photo calendar. The user 70 can select a style of the calendar: wall hanging, desktop style, calendar book, pocket size etc. The user 70 can pick a calendar period (e.g. 6 months, 12 months, 18 months, etc.), the start date (e.g. any month of a year), and the number of months per page. The user 70 also has the option to open up a previously saved calendar project to save the time for defining the calendar parameters.

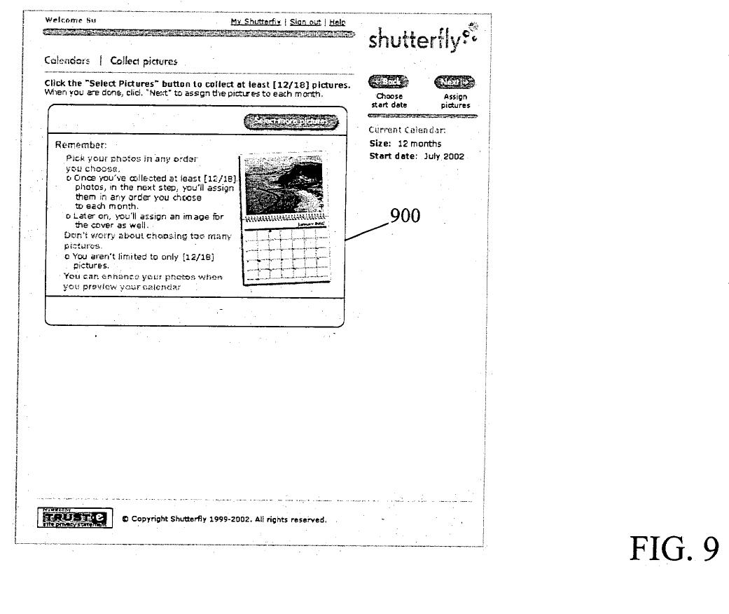

The pictures are next collected in an image collection (box 810). FIG. 9 illustrates an empty image collection 900 in a web page before any digital images are collected. An image collection 900 stores digital images that are selected and collected from the image source. The stored digital images are judged by the user 70 as suitable for being used in creating image-based products such as hardcopy photo albums, hardcopy photo calendars, photo books, greeting cards, photo cards, post cards, note cards, Snapbooks. Since the image-based products are typically to be displayed, shared, or given as a present to someone, the digital images collected in the image collection 900 may require different criteria compared to the digital images that are shared electronically or printed in typical photographic prints. For example, the digital images in the image collection 900 (and 1100) may be of higher resolution, better color saturation, appealing scene composition than other images in the photo albums in the user's web account. The digital images stored in the image collection 900 (and 1100) may also share a particular theme (skiing) or an occasion (a vacation trip).

In one embodiment in accordance to the present invention, an image collection can be a Hypertext Markup Language (HTML) layer in one web page in a web browser. The calendar layout is stored on a different HTML layer in the same webpage. An HTML layer can be implemented using <LAYER> provided in Netscape Navigator, available from AOL Times Warner and using <DIV> for Internet Explorer, available from Microsoft Corporation, Redmond, Washington. In another embodiment in accordance to the present invention, the image collection includes collection photo albums that hold the collected digital images from the user's photo albums. The image collection photo albums are saved in the user account, viewable by the user 70 and can be used for different image-based products. The images in collection photo albums can be extract by a HTML layer during the creation of an image-based product such as hardcopy personalized photo calendars, hardcopy photo album, or greeting cards. Image collected in a HTML layer can also be saved to collection photo albums for being used by different products.

Referring back to the calendar workflow 800, the pictures are next selected an image source (box 815). In accordance to the present invention, the image source can include a user's images uploaded to a photo hosting website saved in the user account and stored on the computer servers and storage devices servicing the website. The image source can include user's digital images saved on a personal computer, or memory device, or stored in a digital camera. A user 70 typically stores personal images in a plurality of photo albums 410 in a user's account at a photo hosting website. The user 70 may select pictures in several of his photo albums for creating the personalized photo calendar (box 820).

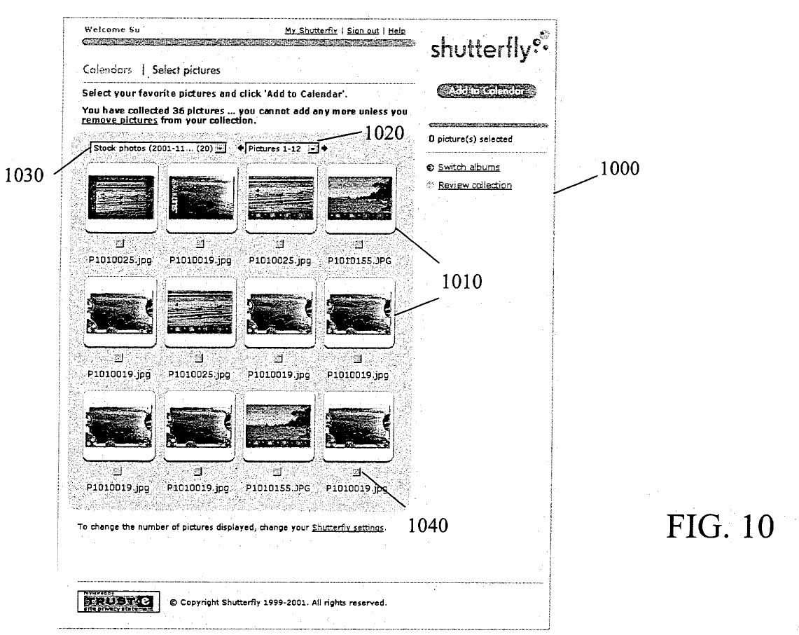

FIG. 10 shows a view of a photo album including a plurality of digital images. Other digital images in the photo album can be viewed by using the picture pull-down menu 1020 to select: “Pictures 1-12”, “Pictures 12-24” . . . etc. Other photo albums can be viewed by selecting different album names using the album pull-down menu 1030. The digital images 1010 are selected by pointing and clicking each image with a mouse. The selection of the digital images is indicated by the selection indicator 1040 below each digital image. The selected digital images can be moved to the image collection 900 by clicking a button “Add to Calendar”. The selection of digital images can also be implemented in other approaches. For example, clicking, drag and drop. The status of the images collected in the image collection 900 may be shown on the web page as the user 70 navigates through different photo albums to look for suitable pictures for the personalized photo calendar.

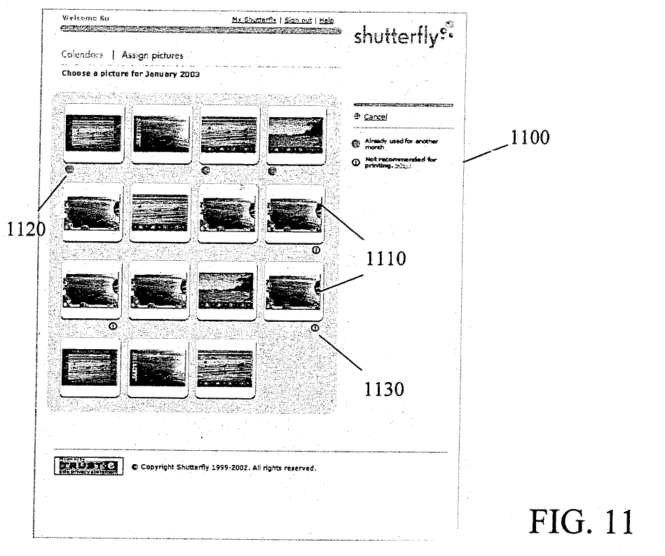

After the digital images are selected, the user 70 reviews the digital images collected in the image collection (box 825). FIG. 11 illustrates an image collection 1100 including a plurality of collected digital images 1110 from the user's photo albums. The assignment indicators 1120 below the collected digital images indicate whether a specific collected digital image is been assigned to a calendar layout as described below. If the quality of an image is not good enough (too low a resolution for example), a warning message 1130 “Not recommended for printing” is shown near the particular image to alert the user 70. If needed, the user can collect more digital images from the photo albums (820).

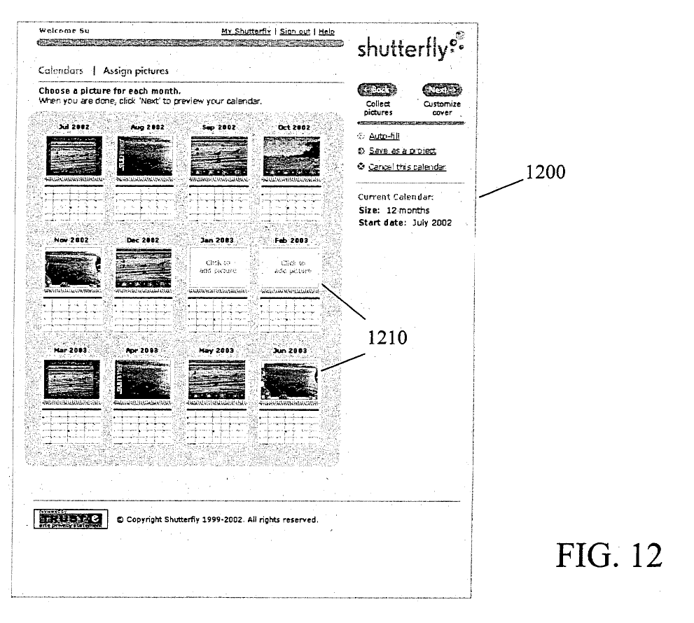

The user 70 can assign the collected digital images 1110 in the image collection 1100 to the calendar layout 1200 to form personalized photo calendars (box 830). As shown FIG. 12, a calendar layout 1200 for a personalized photo calendar includes a plurality of calendar months as defined by the user 70 (in box 805). plurality of image fields 1210 each associated with a date (e.g. a calendar month). Some of the image fields 1210 have received collected digital images 1110 from the image collection 1100. Some are without images.

In accordance to an embodiment of the present invention, the calendar layout 1200 and the image collection 1100 are stored on different HTML layers of the same web page. The calendar layout 1200 is stored on the main HTML layer. The image collection 900,1100 is stored oil the second HTML layer. The information of both layers are cached in a web session such that the switching between the two layers does not require refreshing of the webpage and retrieving information from other locations. This approach therefore provides the advantage of very fast responses for the user 70 to quickly fill all the image fields in a calendar layout. To fill a vacant image field 1210, the user 70 can simply point the mouse curser to and click at the image field in the calendar layout. The clicking triggers the display of the image collection 1100 on the second HTML layer showing the collected digital images 1110. The user 70 can then select and click on one of the collected digital images 1110 in the image collection 1100. The clicking switches the webpage to the first HTML layer showing the calender layout 1200. The collected digital image 1110 clicked automatically appears in the originally vacant image field 1210. The user 70 can also change the image occupying an image field 1210 by following the same procedure (box 845).

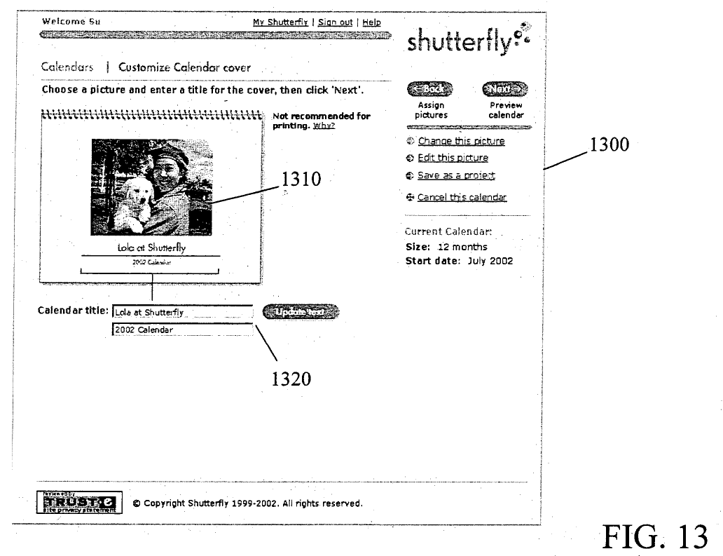

FIG. 13 illustrates a calendar cover layout 1300 of a personalized photo calendar including an image field 1310 and a message field 1320 for entering personalized messages for customization (box 835). The cover layout 1300 includes an image field 1310 for receiving a personalized cover image, which can be filled using the similar procedure for filling the image fields 1210 in the calendar layout 1200 for the calendar pages, as described above. The cover image can be enhanced by typical imaging tools such as cropping, tone adjustment, color saturation, or adding an image border, etc. (box 840). The cover image field 1310 can be adjusted by the user 70 for the best presentation. For example, the user 70 can move or change the size of the cover image field 1310 (box 840). The message field 1320 can include personalized message entered by the user 70, including a title, the user's or the family's names, and the time period of the calendar, etc. The color, size, and type of the fonts can all be selected by the user 70 (box 840). The cover image can be changed by selecting different ones from the image collection 1100 (box 845).

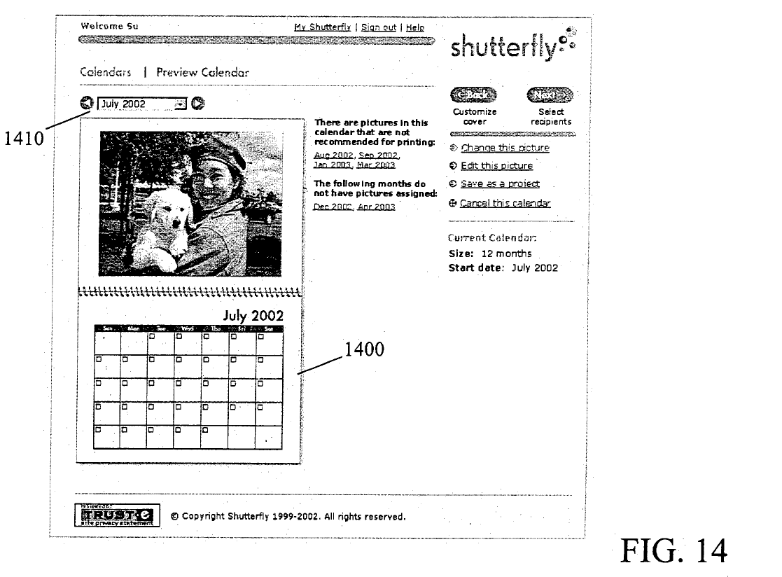

After the calendar cover and the calendar pages are finished, the layout of the calendar having the selected digital images in the image fields are rendered to personalized viewable images of the personalized photo calendar which can subsequently previewed (box 850). FIG. 14 illustrates the previewing of a calendar page in a personalized photo calendar. The user 70 can use the pull-down menu to select the calendar month that he or she wants to preview. The user 70 can also enhance the images in the image fields 1210 and the cover image field 1310 during the previewing process. The preview of the personalized photo calendar can be in planar or perspective views. Details of previewing photo products are disclosed in the above referenced and commonly assigned U.S. patent application Ser. No. 09/684,595, filed on Oct. 5, 2000, titled “Previewing a framed image print”, by Haeberli, the disclosure of which is incorporated herein by reference.

If the user 70 is satisfied with the design of the personalized photo calendar 1400, the user 70 can save it as a project for future use, or order a hardcopy copy of the personalized photo calendar 1400. The ordering process may include the steps of selecting a recipient, entering shipping address, reviewing payment, and making payment. The user 70 can edit the calendar in the ordering process. Details of online ordering image-based products to one or more recipients are disclosed in the above referenced and commonly assigned U.S. patent application Ser. No. 09/436,704, filed on Nov. 9, 1999, titled “Distributing Images to Multiple Recipients”, by Baum, the disclosure of which is incorporated herein by reference.

Various implementations of the systems and techniques described here may be realized in digital electronic circuitry, or in computer hardware, firmware, software, or in combinations thereof. A system or other apparatus that uses one or more of the techniques and methods described here may be implemented as a computer-readable storage medium, configured with a computer program, where the storage medium so configured causes a computer system to operate on input and/or generate output in a specific and predefined manner. Such a computer system may include one or more programmable processors that receive data and instructions from, and transmit data and instructions to, a data storage system, and suitable input and output devices. Each computer program may be implemented in a high-level procedural or object-oriented programming language, or in assembly or machine language if desired; and in any case, the language may be a compiled or interpreted language. Suitable processors include, by way of example, both general and special purpose microprocessors.

A number of embodiments have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components. Accordingly, other embodiments are within the scope of the following claims.

Element Number List

10 system for producing personalized photo calendars

20 online photo system

30 data center

32 server

34 data storage devices

36 computer processor

40 printing and finishing facility

41 printing and finishing facility

42 network server

43 film processor

44 scanner

45 printer

46 finishing equipment

48 shipping station

50 Internet

60 computer terminal

70 user

80 computer network

100 recipient

105 recipient

110 share recipient

200 computer

203 mouse

205 keyboard

206 card reader

207 computer display

208 digital camera

209 memory

210 non-volatile memory

211 operating system

213 application program

217 I/O unit

221 Central Processing Unit (CPU)

223 communication device

225 communications link

230 digital printer

300 graphical user interface

310 photo album

320 calendar layout

330 digital image

350 cell

360 image field

370 image border

400 graphical user interface

410 photo album

420 calendar layout

430 digital image

450 cell

460 image field

480 image border

500 hardcopy personalized photo calendar

510 personalized cover page

520 personalized photo calendar page

530 personal photo

540 personal title

550 calendar layout

560 image filed

570 cells

600 calendar layout

610 image field

620 date cell

700 electronic calendar

710 cells

720 text information

730 header information

740 file folders

750 event information

800 calendar workflow

805 define calendar

810 collect pictures

815 select pictures

820 choose albums

825 review image collection

830 assign pictures

835 customized cover

840 enhance cover

845 change pictures

850 preview calendar

855 enhance pictures

860 order calendar

900 image collection

1000 photo album

1010 digital images

1020 picture pull-down menu

1030 album pull-down menu

1040 selection indicator

1100 image collection

1110 collected digital images

1120 assignment indicator

1130 warning message

1200 calendar layout

1210 image fields

1300 calendar cover layout

1310 cover image field

1320 message field

1400 personalized photo calendar

1410 pull-down menu

What is claimed is:

1. A method for producing an image-based product, comprising:
a) displaying a layout of the image-based product including at least one image field for receiving a digital image;
b) selecting one or more digital images from an image source;
c) storing the selected digital images in an image collection; and
d) moving one or more selected digital images stored in the image collection into the image field in the layout of the image-based product.

2. The method of claim 1 wherein the layout of the image-based product includes a plurality of pages, having at least one image field for receiving a digital image.

3. The method of claim 2 wherein the image-based product includes one or more of a hardcopy photo album, a photo calendar, a photo book, a greeting card, and a photo card.

4. The method of claim 1 wherein the image-based product comprises a calendar and the image field in the layout of the image-based product is associated with a date.

5. The method of claim 4 further comprising selecting a start date and a calendar period.

6. The method of claim 1 wherein the image source includes one or more photo albums each including one or more digital images stored on a computer.

7. The method of claim 1 further comprising uploading the digital images over a computer network to a server.

8. The method of claim 1 further comprising capturing the digital images to be stored at the image source with a digital camera.

9. The method of claim 1 further comprising viewing the image collection and the layout of the image-based product using a web browser at a web user interface.

10. The method of claim 9 wherein the image collection and the layout of the image-based product are stored in different Hypertext Markup Language (HTML) layers of a single web page.

11. The method of claim 9 wherein the selected digital images are moved from the image collection to the image field in the layout of the image-based product by first selecting the image field, and subsequently selecting a digital image in the image collection.

12. The method of claim 9 wherein the image collection includes photo albums storing selected digital images viewable at a web user interface.

13. The method of claim 1 further comprising replacing the selected digital image in an image field in the layout of the image-based product with a different digital image from the image collection.

14. The method of claim 1 further comprising adjusting the image field in the layout of the image-based product can be adjusted by a user.

15. The method of claim 1 wherein the image field in the layout of the image-based product includes personalized information provided by a user.

16. The method of claim 1, further comprising
e) rendering the layout of the image-based product having the selected digital images in the image field to form the image-based product.

17. The method of claim 16, further comprising:
f) previewing the image-based product having the selected digital image.

18. The method of claim 16 further comprising
f) ordering the image-based product having the selected digital image.

19. The method for producing an image-based product of claim 18 further comprising
g) producing the image-based product having the selected digital image.

20. A method for producing a personalized viewable image, comprising:
a) displaying a layout of the personalized viewable image including at least one image field for receiving a digital image;
b) selecting one or more digital images from an image source;
c) storing the selected digital images in an image collection;
d) moving one or more selected digital image stored in the image collection into the image field in the layout of the personalized viewable images; and
e) rendering the layout of personalized viewable images having the selected digital image in the image field to form the personalized viewable image.

21. The method of claim 20 wherein the image collection and the layout of the image-based product are viewable using a web browser at a web user interface.

22. The method of claim 21 wherein the image collection and the layout of the image-based product are stored in different Hypertext Markup Language (HTML) layers of a single web page.

23. A system for producing one or more image-based products, comprising:
a) an image source that stores digital images;
b) an image collection that stores one or more digital images from the image source; and
c) data storage to store a layout of an image-based product, including at least one image field for receiving a digital image stored in the image collection.

24. The system of claim 23 wherein the image collection and the layout of the image-based product are viewable using a web browser at a web user interface.

25. The system of claim 24 wherein the image collection and the layout of the image-based product are stored in different Hypertext Markup Language (HTML) layers of a single web page.

26. The system of claim 23 wherein the image collection includes a photo album stored at a photo web site, wherein the photo album holds digital images viewable at a web user interface.

27. The system of claim 23 wherein the image-based products include one or more of hardcopy photo albums, photo calendars, photo books, greeting cards, and photo cards.

28. The system of claim 23 wherein the digital images stored in the image collection are used by two or more image-based products.

29. A system for producing one or more personalized viewable images, comprising:
a) an image source to store personal digital images;
b) an image collection to store one or more personal digital images selected from the image source to be used in the personalized viewable images; and
c) data storage to store a layout of a personalized viewable image, including at least one image field for receiving a selected personal digital image stored in the image collection.

30. A system for producing one or more image-based products, comprising:
a) means for storing digital images;
b) means for collecting one or more digital images from the image source; and
c) means for storing a layout of an image-based product, including at least one image field for receiving a digital image stored in the image collection.
